(19) United States
(12) Patent Application Publication
(10) Pub. No.: US 2020/0070309 A1
(43) Pub. Date: Mar. 5, 2020

(54) ARRANGEMENT AND PROCESS FOR TREATING A SURFACE

(71) Applicant: L'Air Liquide, Société Anonyme pour I'Etude et I'Exploitation des Procédés Georges Claude, Paris (FR)

(72) Inventor: Cerkez KAYA, Krefeld (DE)

(21) Appl. No.: 16/467,409

(22) PCT Filed: Dec. 6, 2017
(86) PCT No.: PCT/EP2017/081733

§ 371 Date: Jun. 6, 2019

(30) Foreign Application Priority Data
Dec. 8, 2016 (DE) 10 2016 123 816.3

(51) Int. Cl. B24C 5/04; B08B 5/00; B05B 7/14; B24C 1/00

(52) U.S. Cl. CPC B24C 5/04; B24C 1/003; B05B 7/1486; B08B 5/00

(57) ABSTRACT

An apparatus and method for treating a surface with a jet having a multiplicity of particles, including a mixing chamber with an inlet for a stream of propellant gas, the mixing chamber being designed to mix the stream of propellant gas with the multiplicity of particles, and a nozzle, which adjoins the mixing chamber and is connected to it in terms of flow and which has an outlet for the stream of propellant gas, a nozzle cross-sectional area of the nozzle as it progresses from the mixing chamber at first being reduced in size to a minimum nozzle cross-sectional area and then being increased in size again, the inlet having an inlet cross-sectional area, and an area quotient between the minimum nozzle cross-sectional area and the inlet cross-sectional area lying in the range from 10 to 300.

### CROSS REFERENCE TO RELATED APPLICATIONS

This application is a 371 of International PCT Application No. PCT/EP2017/081733, filed Dec. 6, 2017, which claims priority to German Patent Application No. 10 2016 123 816.3, filed Dec. 8, 2016, the entire contents of which are incorporated herein by reference.

### BACKGROUND

The invention relates to an arrangement and a process for treating a surface, in particular with a jet comprising a multiplicity of particles.

In many situations, a surface has to undergo mechanical cleaning. It may for instance be necessary in the production of wires for example to clean the finished product to ensure product quality. In solutions known for doing this, a wide variety of chemical and/or mechanical cleaning processes are used. The following come into consideration for example: grinding, brushing, ultrasonic exposure or superheated steam treatment. In particular, it is also known to treat surfaces with a jet of carbon dioxide particles. These processes are also used in the production of plastic products for removing flash from a surface of the plastic products produced.

A combination of a number of the processes mentioned is often used to achieve the result that is respectively desired in the case of the applications described. However, the results are nevertheless often inadequate and not reproducible and the processes too laborious, with the result that they represent a limiting factor with respect to product quality and also production speed.

In known processes in which carbon dioxide particles are used it is in particular the case that the particle size is not constant and not controllable, with the result that a uniform jet of particles cannot be achieved. In particular, there may be a pulsation of the jet of particles. Uniform cleaning or removal of flash or burr, in particular with a reproducible result, is not readily possible. Often, the process must be repeated a number of times, at least for individual regions of a surface to be treated. Situations in which the kinetic energy of the carbon dioxide particles is not sufficient are also known. In that case, a larger particle size would be desirable. Although it is attempted to achieve this in the prior art, known solutions with particularly large particles have the disadvantage that the particle size can vary greatly. Furthermore, known solutions with particularly large particles are often susceptible to faults, in particular in the case of an automated configuration.

On this basis, the object of the present invention here is to overcome at least partially the technical problems described in connection with the prior art. In particular, an arrangement for the treatment of a surface with which particularly uniform, particularly effective and particularly time-saving treatment of the surface is possible is intended to be presented. A corresponding process is also intended to be presented.

These objects are achieved by an arrangement and a process for treating a surface according to the features of the independent patent claims. Further advantageous refinements of the arrangement and of the process are provided in the respectively dependently formulated patent claims. The features set out individually in the patent claims can be combined with one another in any desired, technologically meaningful way and can be supplemented by explanatory substantive matter from the description, demonstrating further variants for the configuration of the invention.

### SUMMARY

According to the invention, an arrangement for treating a surface with a jet comprising a multiplicity of particles is presented. The arrangement comprises at least:
a mixing chamber with an inlet for a stream of propellant gas, the mixing chamber being designed to mix the stream of propellant gas with the multiplicity of particles, and
a nozzle, which adjoins the mixing chamber and is connected to it in terms of flow and which has an outlet for the stream of propellant gas, a nozzle cross-sectional area of the nozzle as it progresses from the mixing chamber at first being reduced in size to a minimum nozzle cross-sectional area and then being increased in size again,
   the inlet having an inlet cross-sectional area, and an area quotient between the minimum nozzle cross-sectional area and the inlet cross-sectional area lying in the range from 10 to 300.

The arrangement described is used for example in particular in the production of wire and plastic products, but can also be used in other applications, in particular in principle in the case of carbon dioxide jets. With the arrangement described, for example, cleaning the surface of a produced wire or a produced plastic product can be carried out. Flash or burr may also be removed from the surface of a produced wire or plastic product. Removing flash or burr means that excess material is removed from the surface. The excess material may be formed in particular as flash or burr at those places at which parts of a casting mould have been put together and/or at which an inlet for casting material into the casting mould is provided.

The particles are preferably formed from a substance that is liquid or gaseous at room temperature. In particular whenever the substance is gaseous at room temperature, the treatment of a surface can be carried out without residues of the substance remaining on the surface. The substance is preferably carbon dioxide. The particles may in particular take the form of snow, such as for example carbon dioxide snow.

The arrangement, and in particular the component parts of the arrangement that can come into contact with the substance and/or with the particles, is/are preferably formed with a material that can withstand low temperatures to be expected when that happens. In the case of solid carbon dioxide, the temperature may for example lie at approximately −80° C. Steel in particular, preferably high-grade steel, is preferred as the material for the arrangement.

In order to generate the jet comprising the multiplicity of particles, first the stream of propellant gas is provided. This may be performed for example by a compressor. The stream of propellant gas is preferably a stream of compressed air. However, a gas other than air, such as for example nitrogen or carbon dioxide, may also be used.

The stream of propellant gas may be introduced into the mixing chamber through the inlet. The mixing chamber is a space that is closed off with the exception of the openings described. These openings are in particular the inlet and the transition of the mixing chamber to the nozzle. The inlet preferably lies on a side of the mixing chamber opposite from the nozzle. In particular, it is preferred that the mixing chamber is configured in an elongated form, that is to say that the extent of the mixing chamber from the inlet to the nozzle is greater than in any other direction.

In the mixing chamber, the stream of propellant gas can be mixed with the particles. The particles may also be formed in the mixing chamber and mixed thereby or thereafter with the stream of propellant gas. The particles may be formed in the mixing chamber for example by a low temperature and/or by an abrupt change in pressure (expansion) of a liquid substance, such as for example carbon dioxide, a non-laminar, in particular turbulent flow being produced as a result of the change in the state of aggregation in interaction with the stream of propellant gas. The suitability of the mixing chamber for mixing the stream of propellant gas with the particles should be understood as meaning that the mixing chamber is so configured and provided with and/or connected to such auxiliary means that, after passing through the mixing chamber, the stream of propellant gas comprises the multiplicity of particles. The auxiliary means may in particular serve for providing the particles and/or the substance from which the particles are formed. When the stream of propellant gas leaves the mixing chamber, the mixture of the stream of propellant gas with the particles does not yet have to be uniform.

After passing through the mixing chamber, the stream of propellant gas with the particles contained therein enters the nozzle. The nozzle is preferably so configured that the flow generated by the nozzle further intensifies or improves the mixture of the stream of propellant gas with the particles. In particular, the nozzle is preferably so configured that, after passing through the nozzle, the mixture of the stream of propellant gas with the particles is uniform. Such thorough mixing can be achieved by the described form of the nozzle, that is to say by the constriction and subsequent enlargement of the cross-sectional area of the nozzle.

It has surprisingly been found by trials that the ratio between the inlet cross-sectional area and the minimum nozzle cross-sectional area, in particular the area quotient, has a particularly great influence on the thorough mixing of the stream of propellant gas with the particles. It has been found that the influence of the area quotient is in particular considerably greater than the influence of individual customarily varied parameters.

The area quotient is defined as the minimum nozzle cross-sectional area divided by the inlet cross-sectional area. The minimum nozzle cross-sectional area is therefore greater than the inlet cross-sectional area by a factor of 10 to 300. The inlet cross-sectional area is defined as the area content of the area through which the stream of propellant gas can enter the mixing chamber. The nozzle cross section is the area content of the area of the nozzle that can be flowed through by the propellant gas. The area is in this case perpendicular to an axis of the nozzle. The minimum nozzle cross-sectional area corresponds to the smallest value of the nozzle cross-sectional area.

It is also preferred that a quotient of the inlet diameter divided by the volume of the mixing chamber lies in the range from 1/50 to 1/300 and is in particular 1/100.

The described advantages that surprisingly occur were found in trials in particular in a preferred embodiment of the arrangement in which the area quotient lies in the range from 25 to 225, in particular in the range from 25 to 100.

In a further preferred embodiment of the arrangement, the mixing chamber has a mixing chamber cross-sectional area that is at least as large as the inlet cross-sectional area and that is at least as large as the nozzle cross-sectional area at each position of the nozzle.

The mixing chamber cross-sectional area is the area of the mixing chamber that can be flowed through by the stream of propellant gas, a section through the mixing chamber parallel to the nozzle cross-sectional area, and consequently perpendicular to the axis of the nozzle, being considered.

In this embodiment, the mixing chamber is configured to be of such a size that the mixing chamber has a negligible influence on the flow of the stream of propellant gas through the nozzle. Consequently, the surprising effect described further above of the influence of the area quotient is not lessened by an additional possible influence of the mixing chamber cross-sectional area.

In a further preferred embodiment of the arrangement, the inlet cross-sectional area is configured in a circular form. Furthermore, the nozzle cross-sectional area is configured in a circular form, a diameter quotient between a minimum nozzle diameter of the minimum nozzle cross-sectional area and an inlet diameter of the inlet cross-sectional area lying in the range from 4 to 17.

The minimum nozzle diameter is defined as the diameter of the nozzle cross-sectional area at the narrowest point of the nozzle, that is to say where the nozzle cross-sectional area is smallest. The inlet diameter is defined as the diameter of the inlet cross-sectional area. The diameter quotient is defined as the minimum nozzle diameter divided by the inlet diameter. In this embodiment, the minimum nozzle diameter is greater by a factor of 4 to 17 than the inlet diameter. Preferably, the diameter quotient lies in the range from 5 to 15.

The circular configuration of the inlet and of the nozzle allows a round jet to be generated. Such a jet is preferred for most applications. In a round jet, a particularly uniform thorough mixing of the stream of propellant gas with the particles can also be achieved.

A round jet can be achieved in particular in the further preferred embodiment of the arrangement in which at least the mixing chamber and the nozzle are configured rotationally symmetrically about an axis of the arrangement.

In a further preferred embodiment of the arrangement, the nozzle is configured as a Laval nozzle.

A Laval nozzle is especially suited for mixing the stream of propellant gas uniformly with the particles.

In a further preferred embodiment of the arrangement, the particles can be at least partly formed with solid carbon dioxide.

During the operation of the arrangement, the particles are preferably formed from liquid carbon dioxide, which is at least partly transformed into the solid state by changes in pressure, volume and/or temperature. This may be performed in particular by an abrupt expansion and/or by atomization. Carbon dioxide has the advantage that, immediately after impinging on the surface to be treated, it goes over into the gaseous state without leaving any residue. The arrangement preferably has means for providing liquid carbon dioxide. Furthermore, means for generating the solid carbon dioxide particles are preferably provided in the arrangement, and in particular in the mixing chamber.

According to a further aspect of the invention, a process for treating a surface with a jet comprising a multiplicity of particles is presented, an arrangement as described being used.

The special advantages and design features of the arrangement that are described further above can be applied and transferred to the process described, and vice versa.

In a preferred embodiment of the process, the treating of the surface comprises at least one of the following steps:
cleaning the surface, and
removing flash or burr from the surface.
   The specified steps may be carried out alternatively or cumulatively, that is to say that a surface may just be cleaned, just have flash or burr removed or both be cleaned and have flash or burr removed.

### BRIEF DESCRIPTION OF THE DRAWINGS

The invention and the technical environment are explained in more detail below on the basis of the FIGURE. The FIGURE shows a particularly preferred exemplary embodiment, to which however the invention is not restricted. In particular, it should be pointed out that the FIGURE, and in particular the relative sizes represented, are only schematic. In the FIGURE:

FIG. 1 schematically shows a lateral sectional representation of an arrangement for treating a surface.

### DESCRIPTION OF PREFERRED EMBODIMENTS

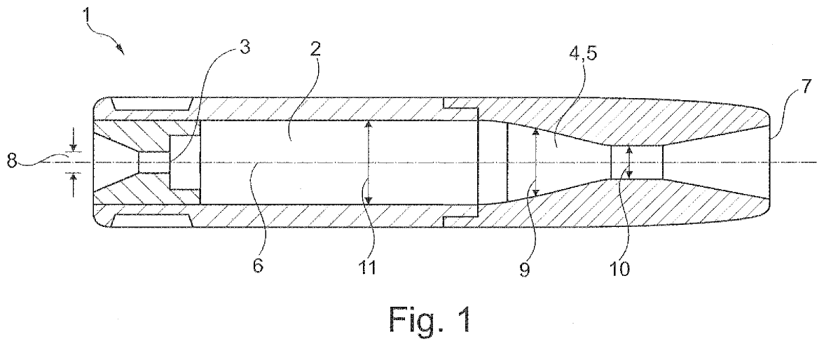

FIG. 1 shows a lateral sectional representation of an arrangement 1 for treating a surface with a jet comprising a multiplicity of particles. The arrangement 1 comprises a mixing chamber 2 with an inlet 3 for a stream of propellant gas. The mixing chamber 2 is designed to mix the stream of propellant gas with the multiplicity of particles. The arrangement 1 also comprises a nozzle 4 configured as a Laval nozzle 5, which adjoins the mixing chamber 2 and is connected to it in terms of flow and which has an outlet 7 for the stream of propellant gas. A nozzle cross-sectional area of the nozzle 4 as it progresses from the mixing chamber 2 is at first reduced in size to a minimum nozzle cross-sectional area and then increased in size again. The inlet 3 has an inlet cross-sectional area, an area quotient between the minimum nozzle cross-sectional area and the inlet cross-sectional area lying in the range from 10 to 300, preferably 25 to 225. In particular with regard to the area quotient, it should be pointed out that FIG. 1 is schematic and not to scale.

The mixing chamber 2 has a mixing chamber cross-sectional area that is larger than the inlet cross-sectional area and just the same size as the nozzle cross-sectional area at the transition between the mixing chamber 2 and the nozzle 4. The mixing chamber 2 and the nozzle 4 are configured rotationally symmetrically about an axis 6 of the arrangement 1. Therefore, the mixing chamber cross-sectional area can be described by way of a mixing chamber diameter 11. The mixing chamber cross-sectional area is at least the same size as the nozzle cross-sectional area at each position along the axis 6 of the nozzle 4. The inlet cross-sectional area and the nozzle cross-sectional area are configured in a circular form, a diameter quotient between a minimum nozzle diameter 10 of the minimum nozzle cross-sectional area and an inlet diameter 8 of the inlet cross-sectional area lying in the range from 4 to 17, preferably from 5 to 15. The minimum nozzle diameter 10 is defined as the smallest value of a nozzle diameter 9.

With the arrangement presented and the process presented for treating a surface, a particularly uniform, reproducible, effective and time-saving treatment of the surface can be achieved. This applies in particular to cleaning and removing flash or burr. The arrangement and the process may be used in particular in the production of wire or plastic products.

### LIST OF DESIGNATIONS

1 arrangement
2 mixing chamber
3 inlet
4 nozzle
5 Laval nozzle
6 axis
7 outlet
8 inlet diameter
9 nozzle diameter
10 minimum nozzle diameter
11 mixing chamber diameter

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-9. (canceled)

10. An apparatus for treating a surface with a jet comprising a multiplicity of particles, the apparatus comprising:
a mixing chamber with an inlet for a stream of propellant gas, the mixing chamber configured to mix the stream of propellant gas with the multiplicity of particles, and
a nozzle, which adjoins the mixing chamber and is fluidically connected and which has an outlet for the stream of propellant gas, a nozzle cross-sectional area of the nozzle as it progresses from the mixing chamber at first being reduced in size to a minimum nozzle cross-sectional area and then being increased in size again,
the inlet having an inlet cross-sectional area, and an area quotient between the minimum nozzle cross-sectional area and the inlet cross-sectional area lying in the range from 10 to 300.

11. The apparatus of claim 10, wherein the area quotient is in the range from 25 to 225.

12. The apparatus of claim 10, wherein the mixing chamber has a mixing chamber cross-sectional area that is at least as large as the inlet cross-sectional area and that is at least as large as the nozzle cross-sectional area at each position of the nozzle.

13. The apparatus of claim 10, wherein the inlet cross-sectional area is configured in a circular form, the nozzle cross-sectional area being configured in a circular form, and a diameter quotient between a minimum nozzle diameter of the minimum nozzle cross-sectional area and an inlet diameter of the inlet cross-sectional area is in the range from 4 to 17.

14. The apparatus of claim 10, wherein at least the mixing chamber and the nozzle are configured rotationally symmetrically about an axis of the arrangement.

15. The apparatus of claim 10, wherein the nozzle is configured as a Laval nozzle.

16. The apparatus of claim 10, wherein the particles are at least partly formed with solid carbon dioxide.

17. A process for treating a surface with a jet comprising a multiplicity of particles, utilizing the apparatus of claim 10.

18. The process of claim 17, the treating of the surface comprising at least one of the following steps:
cleaning the surface, and
removing flash or burr from the surface.
